(19) United States
(12) Patent Application Publication
(10) Pub. No.: US 2017/0082177 A1
(43) Pub. Date: Mar. 23, 2017

(54) SELF-ALIGNING PULLEY

(71) Applicant: Suhale Manzoor, Plymouth, MI (US)

(72) Inventor: Suhale Manzoor, Plymouth, MI (US)

(73) Assignee: Dayco IP Holdings, LLC, Troy, MI (US)

(21) Appl. No.: 15/267,469

(22) Filed: Sep. 16, 2016

Related U.S. Application Data
(60) Provisional application No. 62/220,093, filed on Sep. 17, 2015.

(51) Int. Cl. F16H 7/20; F16H 55/36; F02B 67/06; F16H 7/02

(52) U.S. Cl. CPC F16H 7/20; F16H 7/02; F16H 55/36; F02B 67/06; F16H 2055/366

(57) ABSTRACT

Self-aligning pulleys are disclosed that have a hub, a pulley body concentric about the hub and spaced a distance apart therefrom to define an annular gap, and an annular compliant member disposed in the annular gap between the hub and the pulley body to thereby operatively couple the pulley body to the hub for rotation therewith. The annular compliant member is three-dimensionally compliant to allow the pulley body to adjust in one or more of an axial orientation and a conical orientation relative to the hub to correct misalignments of the hub within a system of pulleys and a belt.

### RELATED APPLICATIONS

This application claims the benefit of U.S. Provisional Application No. 62/220,093, filed Sep. 17, 2015, the entirety of which is incorporated herein by reference.

### TECHNICAL FIELD

The present disclosure relates to pulley assemblies for vehicle engines and, more particularly, to self-aligning pulleys having a compliant member that is three-dimensionally compliant to allow the pulley body to adjust in one or more of axial and conical orientations relative to the hub.

### BACKGROUND

Originally, a crankshaft drove the front end assembly drive (FEAD) system of an engine. A typical FEAD system includes a drive shaft connected to a drive pulley and a number of various driven accessory pulleys, idler pulleys, and/or belt tensioners connected to the drive pulley by means of an endless belt. When a FEAD system is being designed from a system standpoint, it is imperative that all of the accessory pulleys, idler pulleys, and belt tensioner pulleys are in the same plane with the drive pulley.

However, it may not always be possible to accurately position all of the various pulleys in the same plane due to the cumulative stack up of tolerances in the pulleys and the associated mating components. This stack up of tolerances causes misalignment of the belt that leads to a commonly encountered problem called “belt-chirping,” which is regarded as a Noise Vibration and Harshness (NVH) nuisance. FEAD suppliers go to great lengths to ensure the proper alignment of the pulleys in the FEAD system to avoid this occurrence. Further, the axial and radial run-outs of the poly-vee grooves of the endless belt to the associated mating accessory shafts have to be maintained very precisely. Axial or conical misalignment of one or more pulleys may also be responsible for span vibration of the endless belt. Thus, there is a need for new pulleys that are self-aligning and overcome these problems.

### SUMMARY

In one aspect, self-aligning pulleys are disclosed the have a hub, a pulley body with a belt-engaging surface concentric about the hub and spaced a distance apart therefrom to define an annular gap, and an annular compliant member disposed in the annular gap between the hub and the pulley body and operatively coupling the pulley body to the hub for rotation therewith. The annular compliant member is three-dimensionally compliant to allow the pulley body to adjust in one or more of an axial orientation and a conical orientation relative to the hub.

In one aspect, the self-aligning pulley is an idler pulley and includes a bearing having a first race and a second race. In one embodiment, the hub is concentric about the second race of the bearing for rotation with the second race, and the first race is coupled to a shaft.

In one aspect, the self-aligning pulley is a driven pulley with the hub mounted directly to a shaft.

In all aspects, whether an idler pulley or a driven pulley, the hub can have an outer radial surface facing an inner radial surface of the belt-engaging surface and spaced apart to define the annular gap. Here, the compliant member is radially concentric about the outer radial surface of the hub, and has a width that is substantially similar to a width of the hub or a width of the pulley body or has a width that is less than a width of the hub or a width of the pulley body. The compliant member may be axially centered between the hub and the pulley body. In one embodiment, the outer surface of the hub defines a first annular recess, and a portion of the annular compliant member is received in the first annular recess. The inner surface of the pulley body may also define a second annular recess, and have a portion of the annular compliant member received therein. Also, a second compliant member may be present in the annular gap seated in a third recess defined in the outer surface of the hub and in a fourth recess defined in the inner surface of the pulley body. When two annular compliant members are present in the annular gap, they may be spaced apart an axial distance.

In all aspects, whether an idler pulley or a driven pulley, the hub can have a first axial surface and the pulley body can have a second axial surface facing the first axial surface, which are spaced apart from one another to define at least a portion of the annular gap. The compliant member is axially positioned in the annular gap between the first axial surface and the second axial surface. In one embodiment, the first axial surface of the hub and the second axial surface of the pulley body are beveled, and the compliant member is trapezoidal in shape. Also, the pulley body has a face plate and one or more fasteners removably attaching the face plate to another portion of the pulley body while passing through the hub, but each fastener passes through the hub with clearance that enables the pulley body to adjust in the axial and/or conical orientation relative to the hub.

In another aspect, a front end accessory drive system of an engine is disclosed that includes any of the herein described self-aligning pulleys, a second pulley mounted relative to the self-aligning pulley for receipt of an endless belt entrained about the self-aligning pulley and the second pulley, and an endless belt entrained about the self-aligning pulley and the second pulley. In one embodiment, the self-aligning pulley is a driven pulley mounted to a crankshaft. In another embodiment, the self-aligning pulley is an idler pulley having a bearing having a first race and a second race, its hub concentric about the second race for rotation therewith, and the first race coupled to a shaft other than the crankshaft.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view of components in a front end accessory drive.

FIG. 2 is a side perspective view, with a portion cut away, of an embodiment of a self-aligning pulley.

FIGS. 3-10 are partial longitudinal sectional views of various embodiments for the pulley of FIG. 1.

FIG. 11 is a longitudinal cross-sectional view of a second embodiment of a self-aligning pulley.

FIG. 12 is an exploded, perspective view of the self-aligning pulley of FIG. 11.

FIG. 13 is a top view of a pulley system having a traditional pulley conically misaligned with the pulley system.

FIG. 14 is a top view of a pulley system having a self-aligning pulley as disclosed herein that is mounted on a shaft that is conically misaligned with the pulley system.

FIG. 15 is a partial longitudinal cross-sectional view of an exemplary self-aligning pulley having a hub that is conically misaligned with the FEAD system.

FIG. 16 is a partial longitudinal sectional view of an exemplary self-aligning pulley having a hub that is axially misaligned with the FEAD system.

FIG. 17 is a partial longitudinal sectional view of an exemplary self-aligning pulley having a hub that is axially and conically misaligned with the FEAD system.

### DESCRIPTION

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

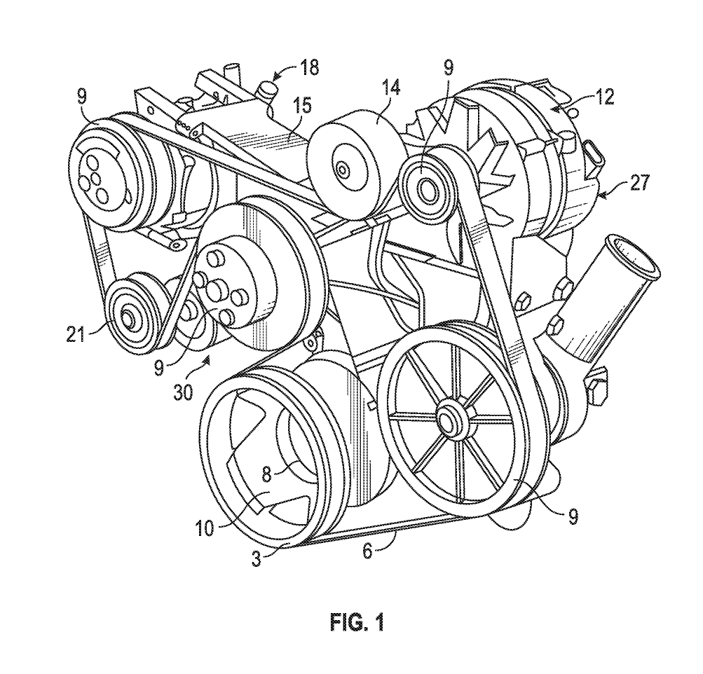

Referring now to FIG. 1, an example of one embodiment of a FEAD system 18 is shown, merely for illustration purposes, that includes an integrated housing 15, having a front surface 30 and a rear surface 27. The rear surface 27 of the integrated housing 15 is preferably mounted to an engine. The FEAD system 18 may be utilized with any engine, including vehicle, marine and stationary engines. The shape and configuration of the integrated housing 15 depends upon the vehicle engine to which it is to be mounted. Accordingly, the integrated housing 15, and more specifically the FEAD system 18, may vary along with the location of and number of engine drive accessories 9 and still achieve the objects of the present invention. A vacuum pump, a fuel injection pump, an oil pump, a water pump, a power steering pump, an air conditioning pump, and a cam drive are examples of other engine drive accessories 9. In FIG. 1, the integrated housing 15 has a plurality of engine drive accessories 9, including an alternator 12 and a belt tensioner 21. The FEAD system 18 may also include one or more idler pulleys 14.

The engine drive accessories 9 are driven by at least one endless drive belt 6, which may be a flat belt, a rounded belt, a V-belt, a multi-groove belt, a ribbed belt, etc., or a combination of the aforementioned belts, being single or double sided. The endless drive belt 6 may be a serpentine belt. The endless drive belt 6 may be wound around the engine drive accessories 9, the alternator 12, the idler pulley(s) 14, the belt tensioner 21, and the drive pulley 3, which is connected to the nose 10 of the crankshaft 8. The crankshaft drives the drive pulley 3 and thereby drives the endless drive belt 6, which in turn drives the remaining engine drive accessories 9.

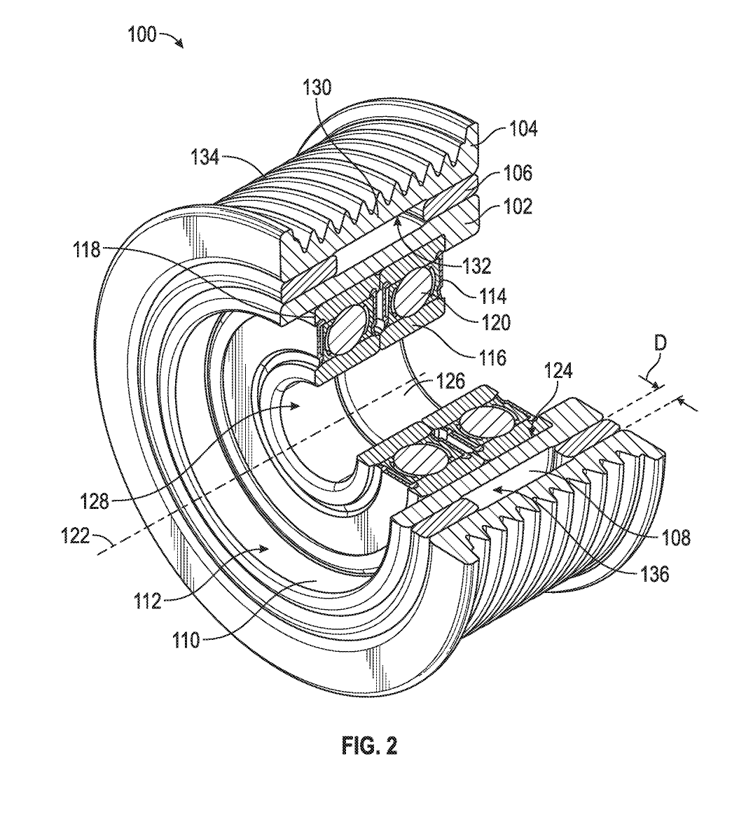

Referring now to FIG. 2, the improvement to the FEAD system 18 is a self-aligning pulley, generally designated by reference 100, which is capable of self-adjusting an axial and/or a conical alignment relative to the FEAD system 18 to compensate for misalignments, which may be caused by cumulative stack up of tolerances. The self-aligning pulley 100 includes a hub 102, a pulley body 104, and one or more compliant members 106 disposed between the hub 102 and the pulley body 104, the compliant member 106 being capable of adjusting a three-dimensionally compliant member to axially and/or conically align the pulley body 104 with the FEAD system 18, relative to the hub 102.

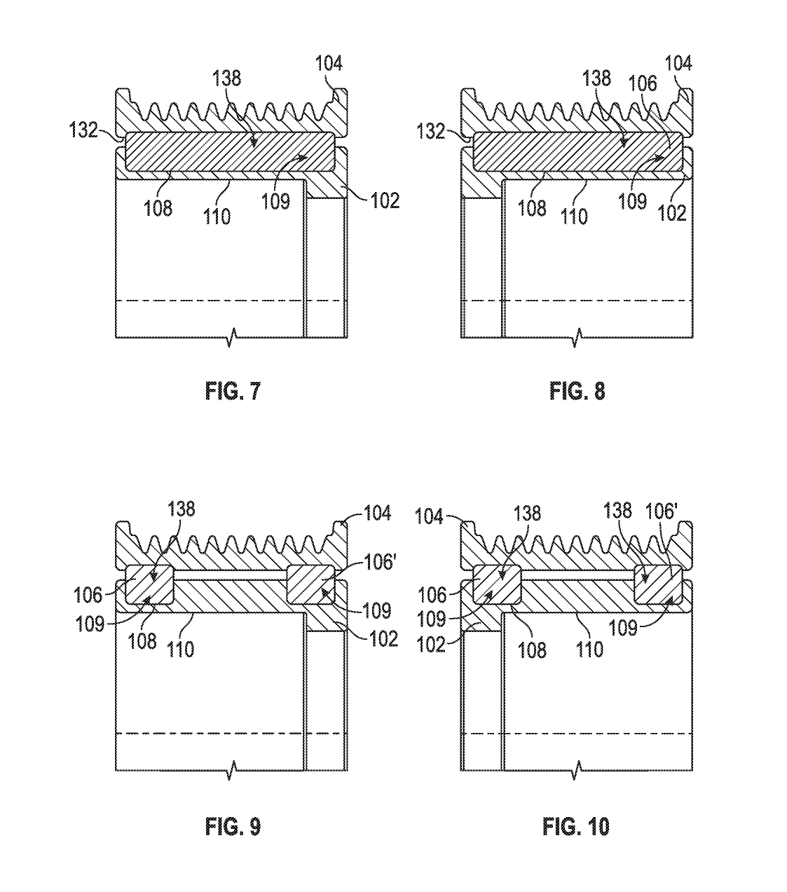

The hub 102 has an outer surface 108 facing radially outward. This outer surface 108 may define one or more hub recesses 109 (FIGS. 7-10) for receiving a portion of the compliant member 106. The hub recesses 109 may be annular recesses or may be one or more arcuate recesses radially spaced apart around the outer surface 108 of the hub 102. Two or more hub recesses 109 may also be axially spaced apart across the outer surface 108 of the hub 102, as shown in FIGS. 9 and 10. In one embodiment, the two or more hub recesses 109 may be evenly distributed axially and/or radially. The hub 102 may have an inner surface 110 defining a central bore 112 for receiving one or more bearings 114 or a shaft (not shown), such that the hub 102 is positioned concentrically about the bearings 114 or the shaft. The hub 102 may be cast, spun, forged, machined, or molded using known or hereinafter developed techniques. Suitable materials for the hub include, but are not limited to, iron, steel, aluminum, other suitable metals, plastics, or a combination thereof, including composite materials.

As shown in FIG. 2, the hub 102 may be positioned concentric about one or more bearings 114, each bearing 114 having an inner race 116, an outer race 118, and a plurality of bearing members 120 positioned between the inner race 116 and the outer race 118. The outer race 118 is rotatable about the inner race 116 of the bearing 114 with respect to an axis of rotation 122. The outer race 118 of the bearing 114 has an outer bearing surface 124 facing radially outward to engage the inner surface 110 of the hub 102, and the inner race 116 may have an inner bearing surface 126 defining an inner cavity 128 for receiving a shaft (not shown). The hub 102 may be coupled to the outer bearing surface 124 of the outer race 118 of the bearing 114 for rotation with the outer race 118 of the bearing 114 about the axis of rotation 122. In one embodiment, the hub 102 may be shaped to engage the inner race 116, which is rotatable relative to the outer race 118 about an axis of rotation 122, and the outer race 118 may be rigidly coupled to the integrated housing 15 (FIG. 1) of the FEAD system 18 (FIG. 1). In one embodiment, the hub 102 may be coupled directly to the shaft (not shown), as in the case of a driven accessory pulley 9 (FIG. 1) or a crankshaft drive pulley 3 (FIG. 1) for example, such that the inner surface 110 of the hub 102 contacts an outer surface of the shaft (not shown).

Still referring to FIG. 2, the pulley body 104 includes a belt-engaging portion 130 oriented generally radially outward away from the hub 102 and an inner surface 132 oriented radially inward towards the hub 102. The belt-engaging portion 130 includes an outer belt-engaging surface 134, which may be flat, contoured to receive a rounded belt, or have V-grooves for mating with the V-ribs of a V-ribbed belt or any other required contoured groove to mate with an endless belt 6 (FIG. 1). The pulley body 104 is positioned concentric with the hub 102 and spaced radially a distance D outward from the hub 102 to define a gap 136 between the hub 102 and the pulley body 104. The inner surface 132 of the pulley body 104 faces the inner surface 108 of the hub 102 across the gap 136. The inner surface 132 of the pulley body 104 may define one or more pulley body recesses 138 (FIGS. 7-10), which may receive a portion of the compliant member 106. The pulley body recesses 138 may be annular recesses or may be one or more arcuate recesses equally and radially spaced apart along the inner surface 132 of the pulley body 104. Two or more pulley body recesses 138 may also be equally and axially spaced apart along the inner surface 132, as shown in FIGS. 9 and 10. The pulley body 104 may be cast, spun, forged, machined, or molded using known or hereinafter developed techniques. Suitable materials for the hub include, but are not limited to, iron, steel, aluminum, other suitable metals, plastics, or a combination thereof, including composite materials.

Still referring to FIG. 2, the one or more compliant members 106 may be positioned in the gap 136 between the hub 102 and the pulley body 104. In one embodiment, the compliant member 106 is positioned inbetween the hub 102 and the pulley body 104 and in contact with the outer surface 108 of the hub 102 and the inner surface 132 of the pulley body 104. The compliant member 106 is coupled with the hub 102 and the pulley body 104 to tie the pulley body 104 to the hub 102 for rotation therewith. The result is that the pulley body 104 and the compliant member 106 rotate with the hub 102 about the axis of rotation 122.

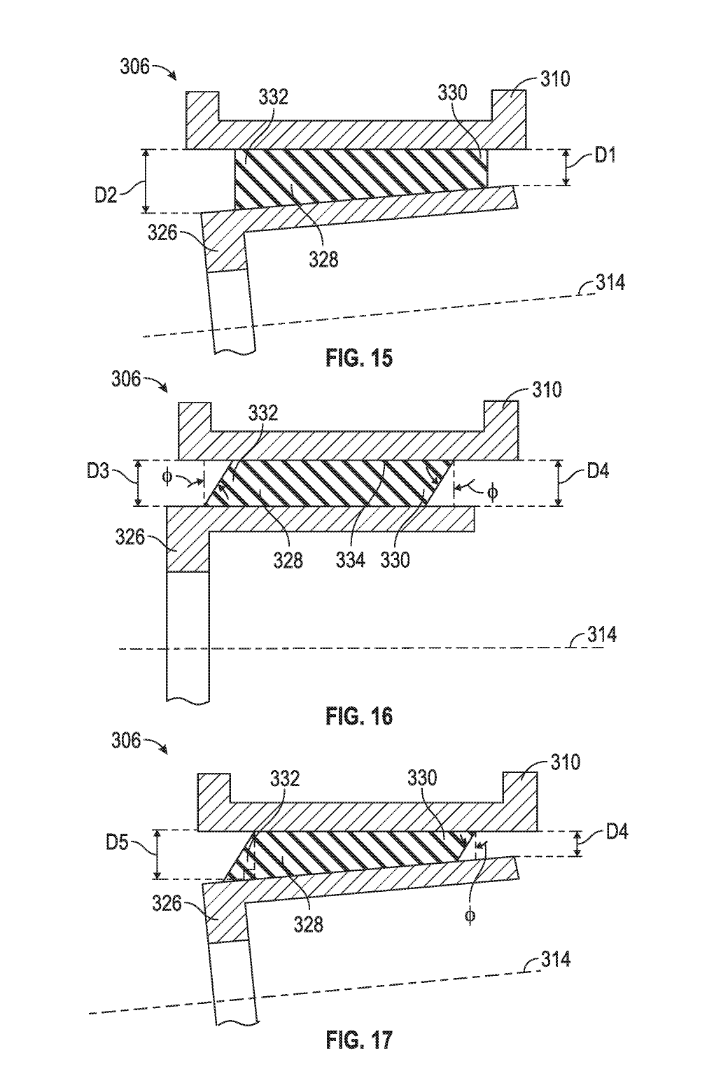

The compliant member 106 is three-dimensionally compliant so that the pulley body 104 is movable in one or more of the axial or conical directions relative to the hub 102. This is illustrated in FIGS. 15-17 and is explained in detail below with the description of these figures. The compliant member 106 typically has three-dimensional flexibility and resilient spring characteristics that enable the compliant member 106 to return to its original shape after repairing a source of misalignment in a FEAD system. Compliant materials suitable for the compliant member 106 may include, but are not limited to, elastomeric materials, foams, fabrics, nylons, or other flexible materials. The compliant member 106 is preferably constructed of a material suitable for automotive engine applications, i.e., suitable to withstand temperatures experienced in the engine and road temperatures and conditions. In one embodiment, the compliant member 106 comprises material having an elastic modulus in a range of about 1 MPa to about 50 MPa, more preferably in a range of about 2 MPa to about 10 MPa. In another embodiment, the compliant member 106 comprises material having an elastic modulus in a range of about 5 MPa to about 50 MPa. The “elastic modulus” of the compliant member 106 refers to the tensile modulus of elasticity at 10% elongation, which is measured using ASTM-D412.

The compliant member 106 is not required to be torsionally compliant, and preferably is not torsionally compliant. For a torsional vibration damper, an elastomeric member requires torsional compliance, but compliance in other directions, such as the compliance needed to allow the pulley body 104 to axially and/or conically adjust to misalignments, must be minimized in order for the torsional vibration damper to effectively dampen vibrations. Therefore, the material selected for the compliant member 106, which requires three-dimensional compliance, has characteristics and/or properties that are fundamentally different than a material that is appropriate for a vibration damper elastomeric member. The compliant member 106 preferably has degrees of compliance substantially greater than a torsional vibration damper member.

In one embodiment, the compliant member 106 may be constructed of a harder material, such as metal or rigid plastic, that provides the required flexibility through a geometric structure, such as a spring structure, for example. The compliant member 106 can be constructed using any geometry and/or material as long as it provides the requisite three-dimensional compliance to allow the pulley body 104 to adjust axially and/or conically to compensate for misalignment of the pulley 100.

The compliant member 106 may be mechanically inserted into the gap 136 defined between the hub 102 and the pulley body 104, such as by press-fitting the material into the gap 136 or by injecting the material into the gap 136. Alternately, the compliant member 106 may be mold-bonded into the gap 136 or post-bonded to either or both of the hub 102 and the pulley body 104 using an adhesive or other bonding method. The compliant member 106 may be coupled to the hub 102 and the pulley body 104 by any other means as long as the compliant member 106 adequately couples the pulley body 104 to the hub 102 for rotation of the pulley body 104 with the hub 102 without slipping. It should be appreciated that the self-aligning pulley 100 does not include or require an inertia member. For instance, the pulley body 104 is not and does not function as an inertia member, and as such may be as light weight as practical. The compliant member 106 and the pulley body 104 do not form a spring mass system effective for damping vibrations.

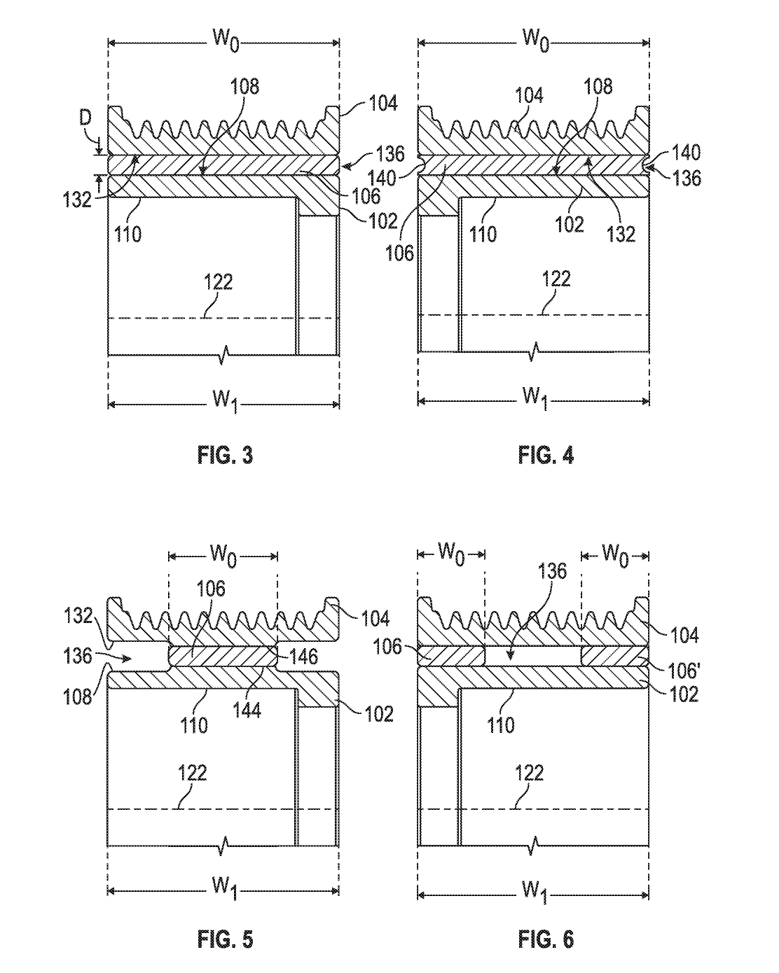

Referring now to FIG. 3, a single compliant member 106 may be radially positioned in the gap D between the hub 102 and the pulley body 104, and the compliant member has a width W₀ that is substantially similar to a width W₁ of the outer surface 108 of the hub 102 or the inner surface 132 of the pulley body 104. In the embodiment shown in FIG. 3, the compliant member 106 is inserted between the hub 102 and the pulley body 104, such as by press-fitting or the like, or post-bonding to the hub 102 and/or the pulley body 104. FIG. 4 shows the single compliant member 106 having width W₀ substantially the same as the width W₁ of the outer surface 108 of the hub 102 or the inner surface 132 of the pulley body 104; however, FIG. 4 illustrates the compliant member 106 molded into the gap 136 between the hub 102 and the pulley body 104. The molding process results in some amount of axial shrinkage shown in either axial surface 140 or the compliant member 106.

Referring to FIG. 5, the compliant member 106 is a single compliant member having a width W₀ that is less than the width W₁ of the outer surface 108 of the hub 102 or the inner surface 132 of the pulley body 104. The outer surface 108 of the hub 102 may have an outer engaging portion 144 protruding radially outward from the outer surface 108 for engaging a first side defining the inner diameter of the compliant member 106. The inner surface 132 of the pulley body 104 may have an inner engaging portion 146 protruding radially inward from the inner surface 132 for engaging a second side defining the outer diameter of the compliant member 106. The compliant member 106 is positioned in the gap 136 between the outer engaging portion 144 of the hub 102 and the inner engaging portion 146 of the pulley body 104.

Referring to FIG. 6, the self-aligning pulley 100 may include a plurality of compliant members 106, 106′ positioned in the gap 136 between the hub 102 and the pulley body 104. Each of the compliant members 106, 106′ has a width W₀ that is less than the width W₁ of the outer surface 108 of the hub 102 or the inner surface 132 of the pulley body 104. Although FIG. 6 shows two compliant members 106, 106′, it is understood that more than two compliant members 106, 106′ may be utilized. The compliant members 106 may be annular and may be spaced a distance apart in an axial direction or may abut against each adjacent compliant member 106′. In one embodiment, annular compliant members 106, 106′ are evenly spaced apart in the axial direction. The compliant members 106, 106′ may also be a plurality of discrete pieces, which may be spaced apart, evenly or otherwise, in either or both of the axial and angular directions.

Referring now to FIGS. 7-10, embodiments are illustrated that include the outer surface 108 of the hub 102 defining one or more hub recesses 109 and the inner surface 132 of the pulley body defining one or more pulley body recesses 138. FIGS. 7-8 illustrate a single compliant member 106 positioned with a portion of the compliant member 106 seated in the hub recess 109 and another portion of the compliant member 106 seated in the pulley body recess 138. In FIG. 7, the hub recess 109 is deeper than the pulley body recess 138; thus, a larger portion of the compliant member 106 is seated within the hub recess 109. In FIG. 8, the pulley body recess 138 is deeper than the hub recess 109; thus, a larger portion of the compliant member 106 is seated within the pulley body recess 138.

FIGS. 9-10 illustrate embodiments similar to those depicted in FIGS. 7-8, except with a plurality of compliant members 106, 106′ seated between the hub recess 109 and the pulley body recess 138. Although only two compliant members 106, 106′ are shown, it is understood that more than two compliant members 106, 106′ may be utilized. In FIG. 9, the hub recesses 109 are deeper than the pulley body recesses 138; thus, a larger portion of each of the compliant members 106, 106′ is seated within the hub recesses 109. In FIG. 10, the pulley body recesses 138 are deeper than the hub recesses 109; thus, a larger portion of each of the compliant members 106, 106′ is seated within the pulley body recesses 138. Seating the compliant members 106 within a cavity formed between the hub recess 109 and the pulley body recess 138 allows the compliant members 106, 106′ to be secured between the hub 102 and the pulley body 104 with a minimal amount of compression of the compliant member 106. In an assembled state, the compliant member 106 may be compressed in a range of about 1% to about 50% of its original shape, or in a range of about 5% to about 45% of its original shape in another embodiment.

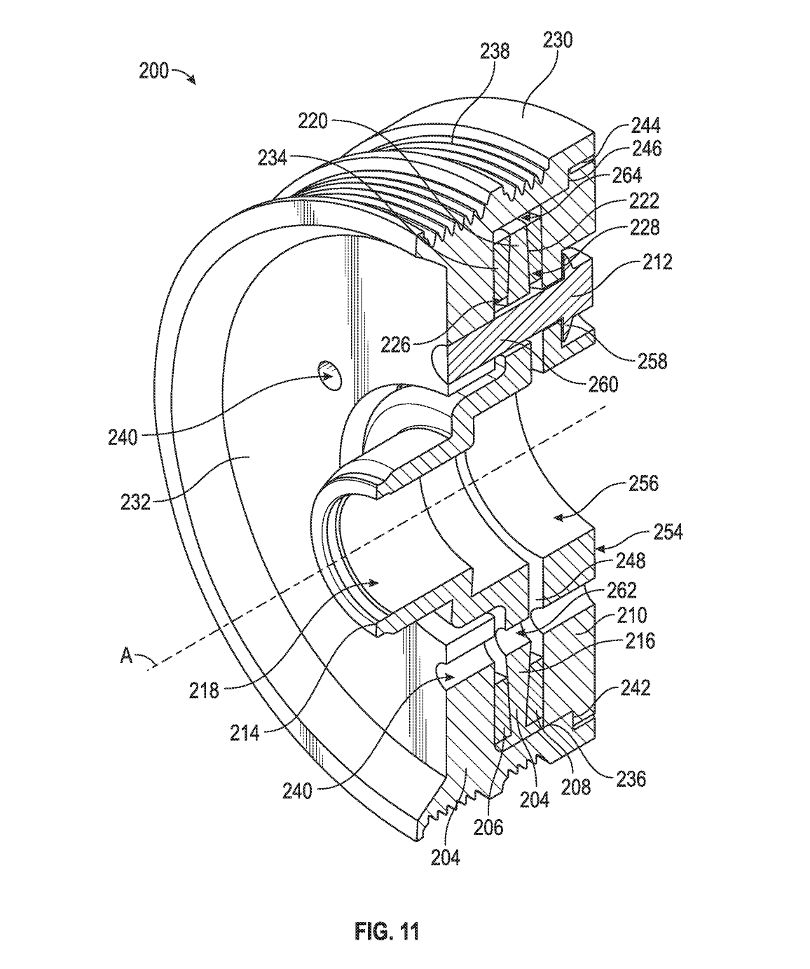

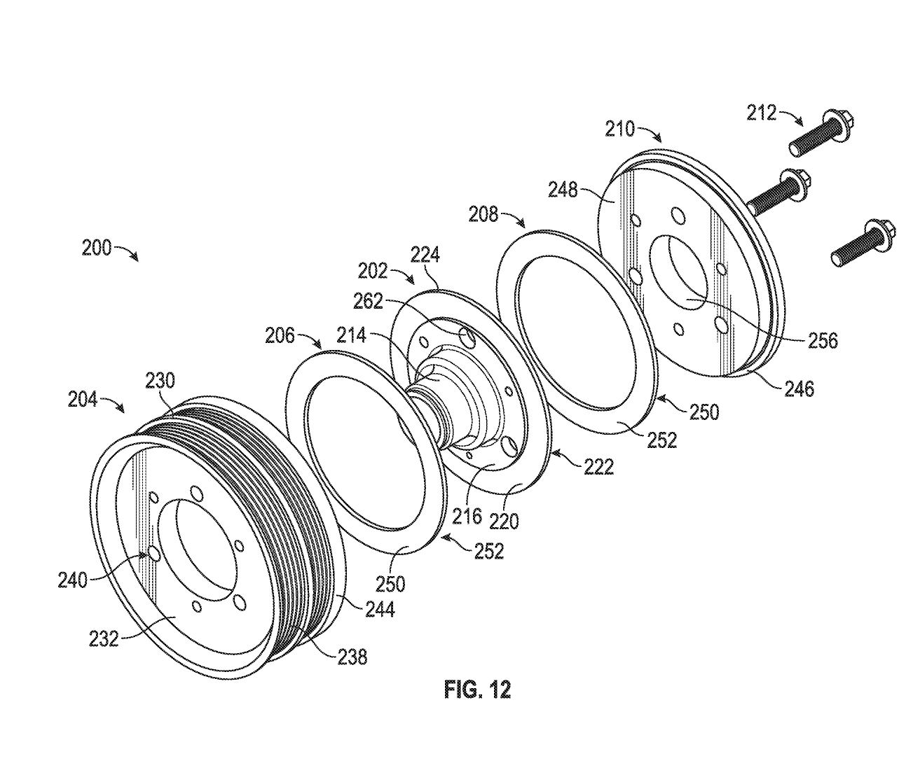

Referring now to FIGS. 11-12, another embodiment of a self-aligning pulley 200 is shown having an axial orientation of compliant members 206, 208 between a hub 202 and a pulley body 204. The self-aligning pulley 200 includes the hub 202, the pulley body 204, a first compliant member 206, a second compliant member 208, a cover plate 210, and a plurality of fasteners 212. The hub 202 includes a shaft-receiving member 214 and a plate 216 extending radially outward about the shaft-receiving member 214. The shaft receiving member 214 defines a bore 218 for receiving a shaft (not shown) and may extend axially in only one direction from the plate 216, which defines a back face of the pulley 200. The face of plate 216, facing the direction that the shaft-receiving member 214 extends, is identified as the first face 220 and opposite thereof is a second face 222 of the hub. The plate 216 terminates in an outermost radial surface 224, and may have one or more non-threaded, enlarged apertures 262 extending axially through the plate 216 for allowing passage of the fasteners 212 through the plate 216 to couple the cover plate 210 to the pulley body 204. The apertures 262 in the plate 216 are enlarged to provide clearance with the fasteners 212 to allow the pulley body 214 to move axially and/or conically relative to the hub 202.

The outermost edges of the first face 220 and the second face 222 of the plate 216, proximate the outermost radial surface 224, may be beveled from a position more proximate an axis of rotation A outward toward the outermost radial surface 224 such that a line coextensive with the beveled surface of the first face 220 and a second line coextensive with the beveled surface of the second face 222 and extending radially outward will cross and thereby define a vertex. The result of such beveled surfaces is that a first gap 226, defined between the hub 202 and the pulley body 204, and a second gap 228, defined between the hub 202 and the cover plate 206, are smaller more proximate the axis of rotation A than more distal the axis of rotation A, and the first and second gaps 226, 228 widen gradually moving radially outward away from the axis of rotation A.

The pulley body 204 has a belt-engaging portion 230 having an inner radial surface 236 and an outer belt-engaging surface 238, which is configured to receive a belt 6 (FIG. 1) as previous described. The pulley body 204 also includes a face guard 232 extending radially inward from one side of the belt-engaging portion 230. The face guard 232 has a third face 234 that faces axially towards the first face 220 of the plate 216 of the hub 202. When assembled, the third face 234 of the face guard 232 is spaced a distance apart from the first face 220 of the hub 202 in an axial direction to define the first gap 226 between the hub 202 and the pulley body 204. With the cover plate 210 installed, the first gap 226 provides sufficient clearance between the first face 220 of the hub 202 and the third face 234 of the face guard 232 to allow the pulley body 204 to move axially and/or conically relative to the hub to correct an alignment of the pulley body 204. The face guard 232 may include a plurality of apertures 240 for receiving the plurality of fasteners 212. The plurality of apertures 240 may be threaded for receiving threaded fasteners 212, such as bolts, for example. The belt-engaging portion 230 of the pulley body 104 may have an inside shoulder 242 at an open end 244 of the belt-engaging portion 230. The inside shoulder 242 faces generally opposite the face guard 232 and may be generally shaped to receive the cover plate 210.

The first and second compliant members 206, 208 are shown as annular bodies having first and second major opposing surfaces 250, 252 as labeled on the first compliant member 206 in FIG. 12, but are not limited thereto. The first compliant member 206 and/or the second compliant member 208 may include one or more alignment features (not shown) in one or more of the first and second major opposing surfaces 250, 252 or an outer surface. The alignment features (not shown) may be configured to engage with mating components (not shown) positioned on the hub 202 and/or pulley body 204. The first major surfaces 250 of the first and second compliant members 206, 208 may be generally perpendicular to the axis of rotation A and oriented to face away from the hub 202, and the second major surfaces 252 of the first and second compliant members 206, 208 face generally opposite the first major surfaces 250 and towards the hub 202. The second major surfaces 252 of the first and second compliant members 206, 208 may be beveled radially inward to have an opposite mating profile to the first face 220 and second face 222 of the hub 202 against which the first compliant member 206 and second compliant member 208, respectively, are meant to be seated. The second major surfaces 152 in both the first and the second compliant members 206, 208 are the surfaces that face towards and are seated against the first and second faces 220, 222 of the hub 102, respectively.

The first and second compliant members 206, 208 are three-dimensionally compliant so that the compliant members 206, 208 allow the pulley body 204 to move in one or more of an axial or conical direction relative to the hub 202. The compliant members 206, 208 may be made of a compliant material having three-dimensional flexibility. Suitable compliant materials may include, but are not limited to, elastomeric materials, foams, fabrics, nylons, or other flexible materials. The compliant members 206, 208 are preferably constructed of a material suitable for automotive engine applications, i.e., suitable to withstand temperatures experienced in the engine and road temperatures and conditions. The compliant members 206, 208 have a degree of compliance substantially greater than a torsional vibration damper member and an elastic modulus as described above. In one embodiment, the compliant members 206, 208 may be constructed of a harder material, such as metal or rigid plastic, that provides the required flexibility through a geometric structure, such as a spring structure, for example. The compliant members 206, 208 can be constructed using any geometry and/or material as long as it provides the requisite three-dimensional compliance to allow the pulley body 204 to adjust axially and/or conically to compensate for misalignment of the pulley 200.

As shown in FIG. 11, the cover plate 210 is seated against the annular inside shoulder 242 of the belt-engaging portion 230 of the pulley body 204. The cover plate 210 has a fourth face 248 generally perpendicular to the axis of rotation A and facing generally towards the plate 216 of the hub 202. A fifth face 254 of the cover plate 210 faces generally opposite the fourth face 248 and may provide a generally flat exterior surface to a front face of the pulley 200. The cover plate 210 may include an inner annular shoulder 246 having a profile opposite a profile of the annular inside shoulder 242 of the pulley body 204 such that the inner annular shoulder 246 of the cover plate 210 mates therewith. As seen in FIG. 11, the cover plate 210 is seated against the inside shoulder 242 at the open end 244 of the belt-engaging portion 230 of the pulley body 204. The cover plate 210 may further include an inner bore 256. When assembled, the fourth face 248 (FIG. 12) of the cover plate 210 is spaced a distance apart from the second face 222 of the hub 202 in an axial direction to define the second gap 228 between the hub 202 and the cover plate 210. The second gap 228 is sufficient to provide clearance between the cover plate 210 and the plate 216 of the hub 202 to enable the pulley body 204 to move axially and/or conically relative to the hub 202.

The fasteners 212 include, but are not limited to, bolts, shoulder bolts, socket head cap screws, screws, rivets, or the like. In one embodiment, the fasteners 212 are bolts, such as a shoulder bolt. As seen in FIG. 11, a shoulder 258 of each fastener 212 hits a hard stop against the cover plate 210, which may include a threaded bore for receiving a threaded end 260 of the fastener 212. Accordingly, each fastener 212 may include a head portion, a threaded end or shaft, and the shoulder therebetween. As seen in the assembled pulley 200 of FIG. 11, the fasteners 212 extend through bores (threaded or non-threaded) in the cover plate 210, through the non-threaded, enlarged apertures 262 in the plate 216 of the hub 202, and are each threaded into a threaded aperture 240 in the face guard 232 of the pulley body 204. The fasteners 212 and/or the cover plate 210 may be such that the head portion of each fastener 212 is countersunk into recesses in the cover plate 210 as seen in FIG. 11. The non-threaded, enlarged apertures 240 in the plate 216 of the hub 202 provide sufficient clearance between the hub 202 and the plurality of fasteners 212 to allow the pulley body 204 to move axially and/or conically relative to the hub 202.

The plurality of fasteners 212 connect the cover plate 210 to the pulley body 204 to place the first and second compliant members 206, 208 against opposing sides 214, 216 of the hub 202. Each of the fasteners 212 passes through separate, individual apertures 262 in the hub 202 with clearance such that the fasteners 212 do not rigidly couple the hub 202 to the pulley body 204 or the cover plate 210. Instead, the fasteners 212 operatively couple the hub 202 to the pulley body 204 and the cover plate 210 for rotation therewith while allowing the pulley body 204 to move axially and/or conically with respect to the hub 202 by way of the first and second compliant members 206, 208. The pulley body 204 is operatively coupled to the hub 202 through contact with the first and second compliant members 206, 208, which, in the assembled state, may be positioned in the first and second gaps 226, 228, respectively, and may be compressed against the first and second faces 220, 222 of the hub 202. The compression of the compliant member 206, 208 is only so much as is needed to tie the hub 202 to the pulley body 204 and not so much that the compliant members 206, 208 lose their effective three-dimensional compliance properties. In one embodiment, compression of the first and second compliant members 206, 208 against the first and second faces 220, 222 of the hub 202 ties the hub 202 to the pulley body 204 for rotation therewith. In another embodiment, a plurality of alignment features (not shown) of the first and second compliant members 206, 208 may engage the pulley body 204 and the hub 202 to rotationally couple the hub 202 to the pulley body 204 for rotation therewith. The compliant members 206, 208 are three-dimensionally compliant to allow the pulley body 204 to move axially and/or conically relative to the hub 202 so that the pulley body 204 can adjust to misalignments of the pulley 200.

In one embodiment of the pulley 200, the outermost radial surface 224 of the hub 202 has a smaller outer diameter compared to the inner diameter of the inner radial surface 236 of the belt-engaging portion 230 of the pulley body 204. The diameter of the outermost radial surface 224 of the hub 202 is small enough that an annular gap 264 is defined between the hub 202 and the pulley body 204. The first and second compliant members 206, 208 are axially positioned against the hub 202, but do not extend into the annular gap 264. The annular gap 264 provides sufficient radial clearance between the plate 216 of the hub 202 and the inner radial surface 236 of the pulley body 204 to allow the pulley body 204 to move axially and/or conically relative to the hub 202.

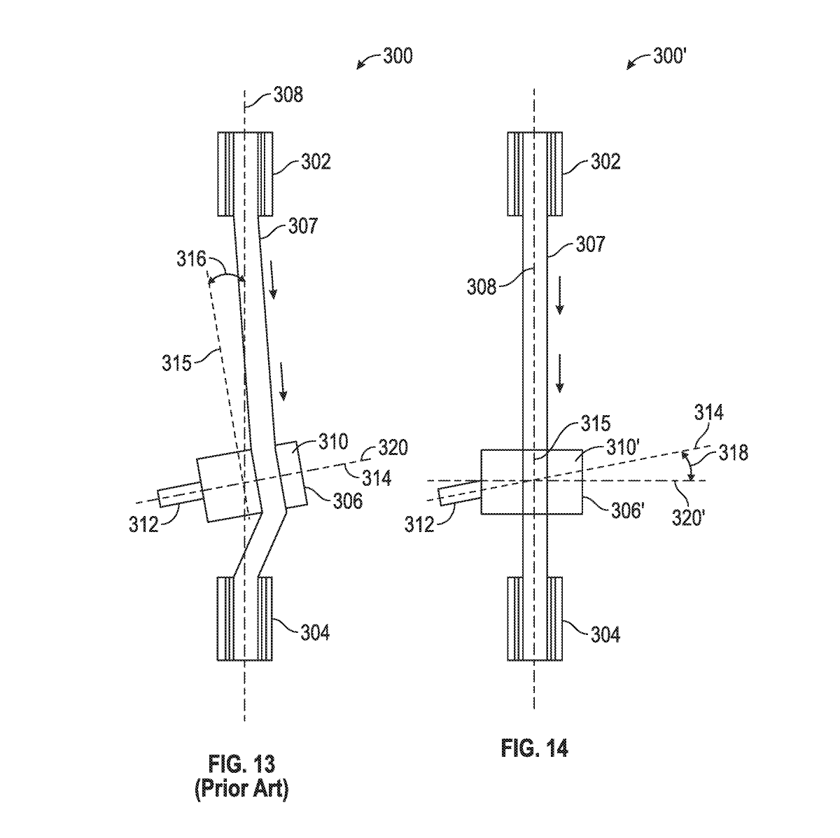

Referring now to FIGS. 13-14, in which the dimensions are exaggerated to illustrate the operation of the self-aligning pulley, a pulley system 300 has a first pulley 302, a second pulley 304, a third pulley 306 of a traditional design mounted between the first pulley 302 and the second pulley 304, and an endless belt 307 traveling around the pulley system 300 in the direction indicated. The first pulley 302 and the second pulley 304 are aligned on a centerline 308. The third pulley 306, which is not a self-aligning pulley as described herein, is mounted to a shaft 312 which is conically misaligned with respect to the centerline 308. The shaft 312 defines a center axis 314. Traditional pulley 306 has a pulley body 310 rigidly coupled to the hub (not shown) and the shaft 312. An axis of rotation 320 of the pulley body 310 generally aligns with the center axis 314 of the shaft 312, and the pulley body centerline 315 is generally at a right angle to the center axis 314 of the shaft 312, which puts the pulley body centerline 315 at an angle 316 with respect to the centerline 308 of the pulley system 300. Because of the misalignment, the endless belt 307 is forced to bend or twist as it passes over the traditional pulley 306 to compensate therefor, which is notorious for causing “belt chirp.”

Referring now to FIG. 14, a pulley system 300′ is shown having a self-aligning pulley 306′ installed in place of the third pulley 306 of FIG. 13. As before, the first pulley 302 and the second pulley 304 are aligned on a centerline 308, and an endless belt 307 travels around the pulley system 300′. Self-aligning pulley 306′ is mounted on the same shaft 312, which defines the center axis 314. The shaft 312 is conically misaligned with the pulley system 300′ such that the center axis 314 of the shaft 312 is not perpendicular to the centerline 308 of the pulley system 300′. In this case, however, the self-aligning pulley 306′ includes a pulley body 310′ rotationally coupled to a hub by one or more compliant members as described in the multiple embodiments disclosed herein. The compliant members allow the pulley body 310′ to conically adjust to the misalignment such that the pulley body centerline 315 aligns with the centerline 308 of the pulley system 300′ in top view. An axis of rotation 320′ of the pulley body 310′ is then at an angle 318 from the center axis 314 of the shaft 312. Conical adjustment of the pulley body 310′ relative to the shaft 312 and the hub aligns the pulley body 310′ with the pulley system 300′, which reduces the twisting and bending of the endless belt 307 as the belt passes over the self-aligning pulley 306′.

The self-aligning pulley 306′ also enables the pulley body 310′ to adjust in an axial direction to axially align (as opposed to conically align) the pulley body centerline 315 with the centerline 308 of the pulley system 300′. The self-aligning pulley 306′ also may enable the pulley body 310′ to adjust radially to compensate for radial misalignment of the pulley body axis of rotation 320 relative to the center axis 314 of the shaft 312.

Referring now to FIG. 15, a partial cross-section of pulley 306′ is shown that has a hub 326 that is conically misaligned with respect to a FEAD system. The dimensions in FIGS. 15-17 are exaggerated for the purpose of illustration. The conical misalignment of the hub 326 is shown as being in the same plane as the plane of the cross section. To compensate for the conical misalignment of hub 326 to align the pulley body 310 with the FEAD system, the compliant member 328 deforms, on account of the compliant nature of the compliant member, such that a first side 330 of the compliant member 328 has a thickness D₁ that is less than a thickness D₂ of a second side 332 of the compliant member 328.

Referring now to FIG. 16, a partial cross-section of pulley 306′ is shown in which the hub 326 is axially misaligned with the FEAD system. The compliant member 328 deforms axially to allow the pulley body 310 to adjust to the misalignment and align with the FEAD system. The compliant member 328 deforms axially, causing the first side 330 to form an angle θ with a line perpendicular to the inner radial surface 334 of the pulley body 306. In this illustration, the thickness D₃ of the compliant member 328 remains generally uniform moving axially from the first end 330 to the second end 332 of the compliant member 328.

Referring now to FIG. 17, a partial cross-section of pulley 306′ is shown having a hub 326 which is axially and conically misaligned with the FEAD system. The conical misalignment is shown as being in the same plane as the plane of the cross section. The compliant member 328 deforms axially and conically to adjust for the axial and conical misalignment and align the pulley body 310 with the FEAD system. A thickness D₄ of the first end 330 of the compliant member 328 is less than a thickness D₅ of the second end 332 of the compliant member 328. In addition, axially deforming compliant member 328 results in the first and second ends 330, 332 forming an angle θ with a line perpendicular to the inner radial surface 334 of the pulley body 310.

The self-aligning pulleys disclosed herein reduce the instance of belt-chirp by aligning the pulley body with the pulley system or FEAD, in particular to minimize twisting and bending of the belt as it passes over a pulley in the FEAD. The self-aligning pulleys reduce belt span vibrations and belt wear, caused by misalignments. Also, the self-aligning pulleys allow for opening the axial and radial run out between the central bore of the hub and the poly-vee grooves. Further, the self-aligning pulleys enable larger tolerances for positioning of FEAD system components, which may reduce the cost of manufacturing the FEAD system and/or its components.

Although the invention is shown and described with respect to certain embodiments, it is obvious that modifications will occur to those skilled in the art upon reading and understanding the specification, and the present invention includes all such modifications.

What is claimed is:

1. A self-aligning pulley comprising:
a hub;
a pulley body having a belt-engaging surface, wherein the belt-engaging surface is concentric about the hub and spaced a distance apart therefrom to define an annular gap; and
an annular compliant member disposed in the annular gap between the hub and the pulley body and operatively coupling the pulley body to the hub for rotation therewith;
wherein the annular compliant member is three-dimensionally compliant to allow the pulley body to adjust in one or more of an axial orientation and a conical orientation relative to the hub.

2. The self-aligning pulley of claim 1, further comprising:
a bearing having a first race and a second race;
wherein the hub is concentric about the second race of the bearing for rotation with the second race.

3. The self-aligning pulley of claim 2, wherein the self-aligning pulley is an idler pulley, and the first race of the bearing is coupled to a shaft.

4. The self-aligning pulley of claim 1, wherein the hub has an outer radial surface and the belt-engaging member has an inner radial surface facing one another and defining the annular gap; wherein the compliant member is radially concentric about the outer radial surface of the hub.

5. The self-aligning pulley of claim 4, wherein the annular compliant member has a width that is substantially similar to a width of the hub or a width of the pulley body or has a width that is less than a width of the hub or a width of the pulley body.

6. The self-aligning pulley of claim 5, wherein the annular compliant member is axially centered between the hub and the pulley body.

7. The self-aligning pulley of claim 4, wherein the outer surface of the hub defines a first annular recess, and a portion of the annular compliant member is received in the first annular recess.

8. The self-aligning pulley of claim 7, wherein the inner surface of the pulley body defines a second annular recess, and a portion of the annular compliant member is received in the second annular recess.

9. The self-aligning pulley of claim 4, further comprising two annular compliant members disposed in the annular gap defined between the hub and the pulley body, wherein the two annular compliant members are spaced a distance apart axially.

10. The self-aligning pulley of claim 8, further comprising a second compliant member received in a third recess defined in the outer surface of the hub and in a fourth recess defined in the inner surface of the pulley body.

11. The self-aligning pulley of claim 4, further comprising a plurality of annular compliant members disposed in the annular gap defined between the pulley inner ring and the pulley outer ring.

12. The self-aligning pulley of claim 11, wherein each of the plurality of annular compliant members is axially spaced a distance apart from each adjacent of the plurality of annular compliant members.

13. The self-aligning pulley of claim 1, wherein the pulley is a driven pulley with the hub mounted directly to a shaft.

14. The self-aligning pulley of claim 1, wherein the hub has a first axial surface and the pulley body has a second axial surface facing the first axial surface and spaced apart therefrom to define at least a portion of the annular gap; wherein the compliant member is axially positioned in the annular gap between the first axial surface and the second axial surface.

15. The self-aligning pulley of claim 14, wherein the first axial surface of the hub and the second axial surface of the pulley body are beveled, and the compliant member is trapezoidal in shape.

16. The self-aligning pulley of claim 14, wherein the pulley body comprises a face plate and one or more fasteners removably attaching the face plate to another portion of the pulley body; wherein each of the fasteners passes through an opening in the hub with clearance that enables the pulley body to adjust in the axial and/or conical orientation relative to the hub.

17. A front end accessory drive system of an engine comprising:
a self-aligning pulley comprising:
a hub;
a pulley body having a belt-engaging surface, wherein the belt-engaging surface is concentric about the hub and spaced a distance apart therefrom to define an annular gap; and
an annular compliant member disposed in the annular gap between the hub and the pulley body and operatively coupling the pulley body to the hub for rotation therewith;
wherein the annular compliant member is three-dimensionally compliant to allow the pulley body to adjust in one or more of an axial orientation and a conical orientation relative to the hub; and
a second pulley mounted relative to the self-aligning pulley for receipt of an endless belt entrained about the self-aligning pulley and the second pulley; and
an endless belt entrained about the self-aligning pulley and the second pulley.

18. The front end accessory drive system of claim 17, wherein the self-aligning pulley is a driven pulley mounted to a crankshaft.

19. The front end accessory drive system of claim 17, wherein the self-aligning pulley is an idler pulley further comprising:
a bearing having a first race and a second race;
wherein the hub is concentric about the second race of the bearing for rotation with the second race, and the first race of the bearing is coupled to a shaft.
